(19) United States
(12) Patent Application Publication
(10) Pub. No.: US 2021/0158438 A1
(43) Pub. Date: May 27, 2021

(54) WORKFLOW GUIDANCE INTERFACE FOR LOAN ORIGINATION SYSTEM

(71) Applicant: Patch of Land, Inc, Sherman Oaks, CA (US)

(72) Inventors: Robert Greenberg, Dallas, TX (US); Sanjay Prajapati, Santa Clarita, CA (US); Chelsea Strong, Encino, CA (US)

(73) Assignee: Patch of Land, Inc, Sherman Oaks, CA (US)

(21) Appl. No.: 16/698,880

(22) Filed: Nov. 27, 2019

(51) Int. Cl. G06Q 40/02; G06F 9/451; G06Q 10/06

(52) U.S. Cl. CPC G06Q 40/025; G06Q 10/06316; G06F 9/453

(57) ABSTRACT

A computer-implemented loan origination system has a memory device that stores an object specific workflow data structure corresponding to each of a plurality of object-specific workflows. The object specific workflow data structure has a plurality of workflow rules corresponding to advancement through each of the plurality of object-specific workflows in a workflow guidance interface that provides a graphical representation of a loan origination workflow. The computer-implemented loan origination system has a processor that generates the workflow guidance interface, which simultaneously operates in conjunction with the computer-implemented loan origination system. The processor also generates a plurality of data objects, which include a lead object, a contact object, an opportunity object, and a loan object. The processor generates the plurality of object-specific workflows corresponding to each of the plurality of data objects.

### BACKGROUND

### 1. Field

This disclosure generally relates to computing systems. More particularly, the disclosure relates to the field of financial computing systems.

### 2. General Background

In order to process a loan, such as a mortgage, many lenders have a detailed process called loan origination, which outlines how the loan is to be handled from the start of the loan application process all the way to the funding of the loan at closing. Although advances in technology have helped spur automation in many industries, the lending industry has not kept up with the pace of such other industries. Many tasks continue to be performed manually by humans employed by a lender.

Given the significant size of many mortgages and the various complexities involved in the loan origination process, many lenders still opt to have various humans involved in the loan origination process. After all, computing systems are prone to security vulnerabilities as well as error, giving more credence to the usefulness of having human beings involved in the loan origination process, at a minimum, to perform validation of automated tasks prior to closing and funding of a mortgage. Furthermore, certain tasks in the loan origination process are just not performed that well by conventional computing configurations. For example, loan applicants often select a lender based on human-to-human interaction with a loan officer. The dialogue leading up to a potential customer actually becoming a loan applicant often times involves more than just simple questions and answers about loan details, such as mortgage rates. In particular, the potential customer often wants to establish a comfort level with the loan officer that the loan officer will be there to help navigate the potential loan applicant throughout the loan process, which is often daunting for many potential loan applicants. The potential loan applicant typically wants to know that a human loan officer, with whom there is that comfort level, will be available to answer atypical questions not recognized by an automated system, discuss issues that may be only tangentially related to actual loan specifics (e.g., the current state of the real estate market in a particular geographic location), and have conversations that may be completely off-topic from loan specifics (e.g., how well a particular sports team is doing).

As another example, conventional computing configurations often lack sufficient computer vision capabilities to perform an appraisal that is on par with that of a human appraiser. For instance, obtaining an adequate appraisal often involves much more than a comparison of the square footage and number of bedrooms in comparable homes in a geographic location. Other factors (e.g., quality of a home's view, quality of finishes in the home, etc.) are somewhat subjective, and can only be satisfactorily visualized by competent human appraisers.

Accordingly, significant human involvement in the loan origination process, along with a degree of automation, is typically desired both by lenders and loan applicants alike. Yet, such human involvement is often fraught with human inefficiencies, even with automation. For example, one person may be performing a task for the lender that was not supposed to be performed yet. As another example, documents may get lost as they are shuffled amongst different people. In essence, current loan configurations represent a hybrid computing-human approach that represents the desire of lenders and loan applicants to have both, but that has not realized the efficiencies of many other automated systems. For example, many current loan origination configurations take the same amount of time to process a loan, from start to finish, that was present before recent advances in computing automation.

Therefore, many current loan origination configurations have not effectively managed the computing-human interaction that is so central to the particular area of loan origination.

### SUMMARY

A computer-implemented loan origination system (“LOS”) has a memory device that stores an object-specific workflow data structure corresponding to each of a plurality of object-specific workflows. Furthermore, the object-specific workflow data structure has a plurality of workflow rules corresponding to advancement through each of the plurality of object-specific workflows in a workflow guidance interface that provides a graphical representation of a loan origination workflow.

Moreover, the computer-implemented LOS has a processor that generates the workflow guidance interface, which simultaneously operates in conjunction with the computer-implemented LOS. The processor also generates a plurality of data objects, which include a lead object, a contact object, an opportunity object, and a loan object. Additionally, the processor generates the plurality of object-specific workflows corresponding to each of the plurality of data objects. The plurality of object-specific workflows includes a lead object workflow, a contact object workflow, an opportunity object workflow, and a loan object workflow. Finally, the processor determines an object position within a plurality of object indicia and an object-specific workflow position within a plurality of workflow pipeline indicia based upon compliance with the plurality of workflow rules so that the object position and the object-specific workflow position are rendered within the workflow guidance interface by a computing device. The plurality of object indicia corresponds to the plurality of data objects. In addition, the plurality of workflow pipeline indicia corresponds to the plurality of object-specific workflows.

As an alternative, a computer program product may have a computer readable storage device with a computer readable program stored thereon that implements the functionality of the aforementioned computer-implemented LOS. As yet another alternative, a process that utilizes a processor may implement the functionality of the aforementioned computer-implemented LOS.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates an LOS configuration.

FIG. 2 illustrates a system configuration for the computer-implemented LOS platform illustrated in FIG. 1.

FIG. 3 illustrates a loan origination workflow pipeline that may be utilized by the computer-implemented LOS platform illustrated in FIG. 1.

FIG. 4A illustrates a lead list that the loan officer may view to initiate contact with various potential loan applicants.

FIG. 4B illustrates the workflow GUI rendering a lead data entry form.

FIG. 5 illustrates the workflow GUI depicting a disposition form.

FIG. 6 illustrates the workflow GUI rendering the plurality of object indicia with redirection to the contact object indicia.

FIG. 7 illustrates the computing device, corresponding to the transaction coordinator, rendering the workflow GUI to depict the opportunities object indicium indicating the current stage in the loan origination workflow pipeline as being the opportunity object, illustrated in FIG. 3.

FIG. 8A illustrates redirection to the loan object indicium.

FIG. 8B illustrates an example of a workflow data structure that may be utilized to indicate rules for advancement and/or retreat within an object-specific workflow, such as the loan object workflow, as well as advancement and/or retreat within the corresponding pipeline indicium, such as the loan object pipeline indicium.

FIG. 8C illustrates an example of property data being selected from the loan object data menu.

FIG. 8D illustrates an example of borrower data being selected from the loan object data menu.

FIG. 8E illustrates an example of underwriter data being selected from the loan object data menu.

FIG. 9 illustrates a process that may be utilized by the computer-implemented LOS platform to provide a workflow guidance interface.

### DETAILED DESCRIPTION

A workflow guidance interface is provided for an LOS. Instead of removing humans from the workflow, the workflow guidance interface improves the visual interaction between human operators of the computing devices utilizing the LOS. For example, the workflow guidance configuration has a graphical user interface (“GUI”) that includes various visual features that automatically guide the human operators of the computing devices utilizing the LOS from one stage of the loan origination process to the next. In other words, the workflow guidance interface improves the interaction between human operators and computing devices, rather than attempting to automate tasks performed by human operators. By improving the usability of the computing devices in the LOS, the workflow guidance configuration removes, or minimizes, human inefficiencies and errors, while also maintaining the human operator involvement that is so pivotal to the mortgage lending industry.

To facilitate implementation of the workflow guidance interface, the LOS may implement a workflow data structure that is specific to generating one or more portions of the workflow guidance interface, and enforcing a plurality of workflow rules that are visually manifested through the workflow data structure. In practical terms, the workflow data structure ensures that one stage of a loan origination workflow pipeline may not be advanced to until one or more previous stages of the loan origination workflow pipeline have been completed as necessitated by the plurality of workflow rules. As a result, different users with different roles in the loan origination process are prevented from accessing certain stages of the loan origination workflow pipeline until one or more criteria have been met for previous stages in the loan origination workflow pipeline. For example, the workflow guidance interface prevents the user from visually advancing through the GUI corresponding to the loan origination workflow pipeline until that user, or other responsible users, have completed the necessary tasks for the current stage of the loan origination workflow pipeline.

Furthermore, the workflow guidance interface utilizes automatic data propagation to provide data from various data objects in the loan origination workflow to subsequent stages of the loan origination workflow pipeline. Rather than having different users in the workflow pipeline have to reenter the same data from different data objects at different stages of the loan origination workflow pipeline, the workflow guidance interface is able to render data fields common to other data objects in the loan origination workflow pipeline.

Furthermore, the workflow guidance interface may obtain data objects from different loan origination workflows. As an example, a loan applicant may be a previous customer that had applied for a mortgage with the same lender. Rather than having to reenter much of the loan applicant's information for the new loan origination workflow, the workflow guidance interface automatically populates and renders the corresponding data fields in the new loan origination workflow. Additionally, the workflow guidance interface may automatically generate templates to comply with state-specific regulations. Rather than having to have a third-party manual generation of documents for each state for a particular mortgage, the workflow guidance interface may automatically render a state-specific template with pre-populated state requirements.

Moreover, the workflow guidance interface performs automatic redirection to various objects upon completion of object-specific workflows. In other words, the GUI renders a loan origination workflow of stages that have to be completed for each data object. In addition to preventing the user from visually advancing from one stage to the next in the object-specific workflow, the workflow guidance interface may prevent the user from visually advancing to subsequent data objects within the loan origination workflow. Upon completion of all of the necessary tasks within an object-specific workflow, the workflow guidance interface may automatically redirect the GUI to display the next data object, and its corresponding object-specific workflow, without the user having to select the next data object. Accordingly, the workflow guidance interface provides a visual indication to the user of compliance with the workflow rules by having the GUI visually advance from one object to the next.

Finally, the workflow guidance interface utilizes an alert engine to generate one or more alerts based on one or more service level agreements (“SLAs”) integrated within the workflow data structure. In particular, the workflow data structure may mandate that a particular task visually depicted for an object-specific workflow has to be completed before the user may perform the next task that is visually depicted for the object-specific workflow. The SLA for that workflow rule may be a field within the workflow data structure, which also has other fields indicating a current task, previous task, and/or subsequent task. For example, the SLA may be a time-based condition for completion of the current task for the user to be allowed to advance to performing the next task. In one embodiment, an alert message may be transmitted to a computing device, which may be the same or a different computing device than the one utilized to interact with the workflow guidance interface, corresponding to a user to alert the user to perform the current task for advancement to the subsequent task in the object-specific workflow.

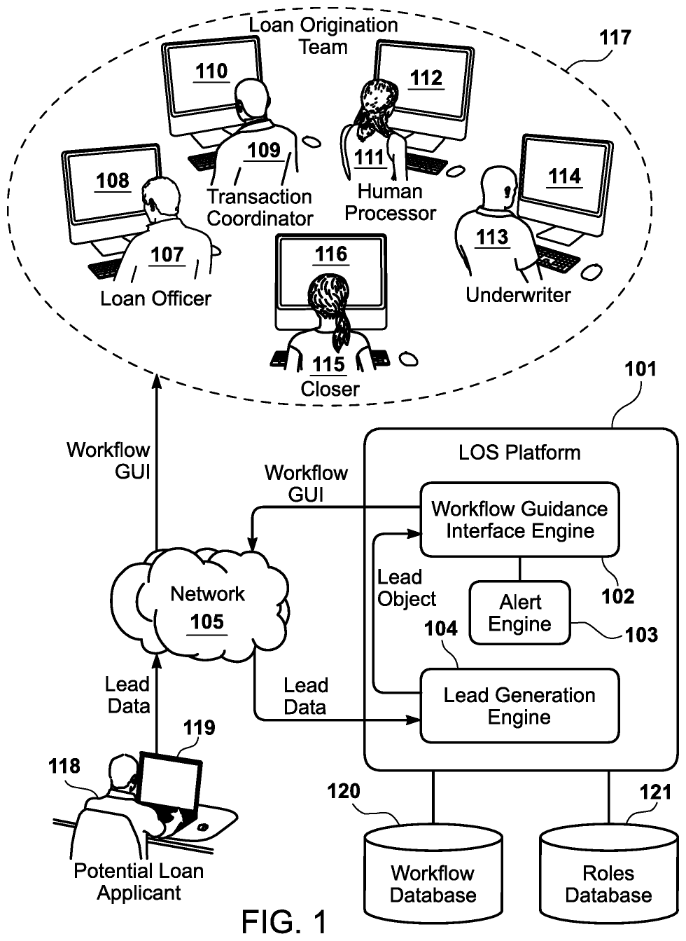

FIG. 1 illustrates an LOS configuration 100. Through a computer-implemented LOS platform 101, the LOS configuration 100 may communicate with both a potential loan applicant 118 and a loan origination team 117 of a lender. For example, the computer-implemented LOS platform 101 may have integrated customer relationship management (“CRM”) functionality (e.g., via a single system rather than multiple systems communicating with one another) that allows for both lead generation and loan origination workflow processing. Accordingly, the potential loan applicant 118 may utilize a computing device 119 (e.g., personal computer (“PC”), laptop computer, smartphone, tablet device, etc.) to provide lead data through a network 105 to the computer-implemented LOS platform 101, which may be implemented on a server remotely situated from the computing device 119. For example, the computer-implemented LOS platform 101 may operate as, or be in operable communication with, a webserver. The potential loan applicant 118 may fill out an online form via a website hosted by the webserver. (Alternative forms of lead submissions (e.g., phone call, chat session, text message, etc.) may be used by the potential loan applicant 118 to generate and send the lead, directly or indirectly, to the LOS platform 101.)

Upon receiving the lead data, the computer-implemented LOS platform 101 may generate a lead object, via a lead generation engine 104. (An “object” referred to herein may be a data construct (e.g., database record, data type, data class, data container, etc.) that is used to invoke a particular instance of a set of data with one or more predefined properties (i.e., associated functionality, user permissions, etc.).) Furthermore, the lead generation engine 104 may send the lead object to a workflow guidance interface engine 102, which generates a workflow GUI, and/or data associated with a workflow GUI. The lead object is indicative of a data set corresponding to the potential loan applicant 118, who has not yet been contacted by the loan origination team 117 of the lender for the particular loan that has been requested by the potential loan applicant. (The potential loan applicant may have previously applied for other loans via the lender, and the computer-implemented LOS platform 101 may utilize its integrated CRM functionality to retrieve data from a CRM database corresponding to the previous loan applications of the potential loan applicant.) Accordingly, the workflow guidance interface engine 102 may send the workflow GUI, and/or data associated with the workflow GUI, to one or more computing devices associated with one or more members of the loan origination team 117 of the lender, for rendering of the workflow GUI. For example, the workflow guidance engine 102 may initially send the workflow GUI, and/or data associated with the workflow GUI, to a computing device 108 associated with a loan officer 107. As an example, the computer-implemented LOS platform 101 may utilize a round robin configuration that assigns the last-in-queue loan officer 107 to the loan. (The round robin configuration is just one example; other types of configurations may be used instead to perform queue management. For example, if the potential loan applicant 118 previously applied for a loan with the lender, the loan officer previously assigned may be reassigned to handle this particular loan.)

Upon completion of certain objectives, as determined by the workflow guidance interface engine 102, the workflow GUI may then be presented to various members of the loan origination team 117 to visually guide the members of the loan origination team 117 through the loan origination process. For example, the workflow guidance interface engine 102 may monitor data sent to, and received from, various computing devices associated with the loan origination team 117 to determine completion of various stages of workflows, and then automatically send one or more alerts (e.g., visual pop-ups, messages, etc.), via an alert engine 103, to various members of the loan origination team, who may have not participated up to that point, to perform one or more tasks. In essence, the workflow guidance interface engine 102 begins with a lead generated via a CRM component, and initiates a visual workflow based on a lead object, which may then result in the generation of additional objects (e.g., contact object, opportunity object, and/or loan object) to help the loan origination team 117 visually navigate the loan origination process via the workflow GUI.

Accordingly, the workflow GUI may prompt and/or prevent access to the workflow GUI by various members of the loan origination team 117 and their corresponding computing devices (e.g., the computing device 108 associated with the loan officer 107, the computing device 110 associated with the transaction coordinator 109, the computing device 112 associated with the human processor 111, the computing device 114 associated with the underwriter 113, and/or the computing device 116 associated with the closer 115). By visually displaying one or more workflow pipelines, the workflow GUI improves the usability of the computing devices associated with the loan origination team 117. Rather than different team members uploading data in a disparate, uncoordinated manner, which often leads to inefficiencies, the workflow GUI utilize a workflow data structure stored in a workflow database 120 to implement one or more workflow rules, which may be stored in the same workflow database 120, or in a different rules database 121. In one embodiment, the one or more workflow rules are integrated within the workflow data structure, and are visually implemented by the workflow interface engine 102 via the workflow GUI, and/or data associated therewith. As such, the members of the loan origination team 117 are not removed from the loan origination process via automation, but rather participate in an improved visual interaction (e.g., via one or more users inputs) with their corresponding computing devices.

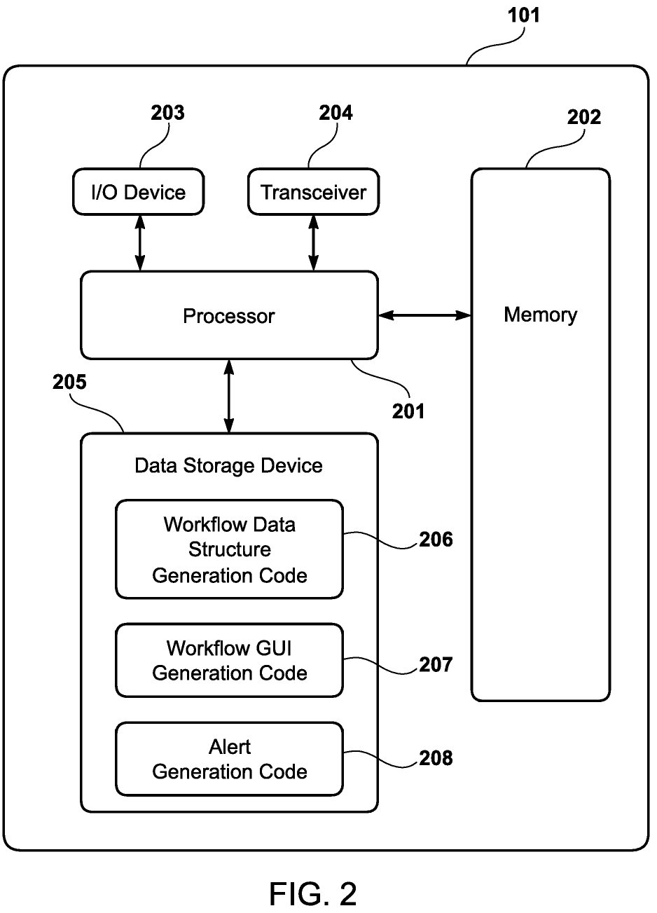

FIG. 2 illustrates a system configuration for the computer-implemented LOS platform 101 illustrated in FIG. 1. In particular, a processor 201, which may be specialized for rendering GUIs, generating data structures, and/or generating alerts may be used to perform the operations illustrated in FIG. 1 for GUI workflow generation and management. For example, the processor 201 may be capable of generating a workflow data structure. Furthermore, a memory device 202 may store the workflow data structure, or portions thereof, for processing by the processor 201 prior to storage in the workflow database 120, illustrated in FIG. 1. In essence, the workflow data structure allows the processor 201 to process data in an optimal manner for specific workflow GUI generation and management, via one or more workflow rules that may be integrated within the workflow data structure. The memory device 202 may also store computer readable instructions performed by the processor 201. As an example of such computer readable instructions, a data storage device 205 within the system configuration may store workflow data structure generation code 206, workflow GUI generation code 207, and alert generation code 208. The memory device 202 may also store computer readable instructions performed by the processor 201. As an example of such computer readable instructions, a data storage device 205 within the system configuration may store data structure generation code 206, workflow GUI generation code 207, and alert generation code 208. The processor 201 may execute the workflow data structure generation code 206 to generate the workflow data structure stored by the workflow database 120, illustrated in FIG. 1. Furthermore, the processor 201 may execute the workflow GUI generation code 207 to generate the workflow GUI that prompts and/or restricts access to the workflow GUI by the loan generation team 117 to improve user interaction (e.g., via one or more user inputs) with the computer-implemented LOS platform 101. Finally, the processor 201 may execute the alert generation code 208 to generate one or more alerts for the alert engine 103 illustrated in FIG. 1.

Moreover, the system configuration may have one or more input/output (“I/O”) devices 203 that may receive inputs and provide outputs. Various devices (e.g., keyboard, microphone, mouse, pointing device, hand controller, etc.) may be used for the I/O devices 203. The system configuration may also have a transceiver 204 to send and receive data. Alternatively, a separate transmitter and receiver may be used instead.

Although the system configuration for the computer-implemented LOS platform 101 illustrated in FIG. 1 is discussed in the context of a server, one or more of the components of the computer-implemented LOS platform 101 may be implemented at a rendering device that renders the workflow GUI. For example, a computing device utilized by one of the members of the loan origination team 117 may implement code to fully, or partially in conjunction with a server, invoke the workflow guidance interface engine 102, thereby allowing for cloud-based, localized, or a hybrid configuration for generation and enforcement of the plurality of workflow rules through the workflow GUI.

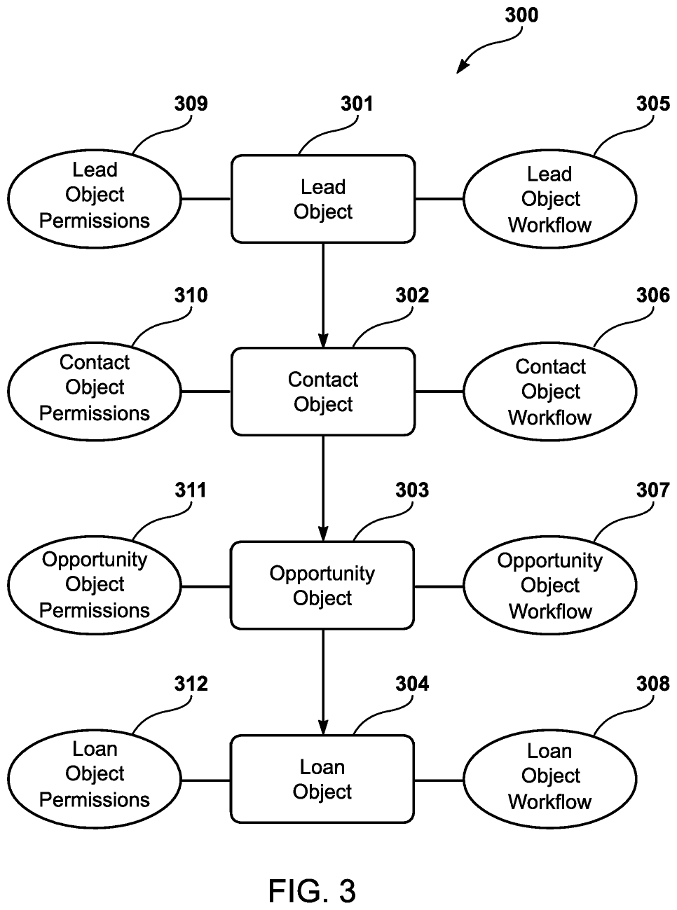

FIG. 3 illustrates a loan origination workflow pipeline 300 that may be utilized by the computer-implemented LOS platform 101 illustrated in FIG. 1. In particular, the workflow pipeline 300 has a plurality of data objects, such as a lead object 301, a contact object 302, an opportunity object 303, and a loan object 304. Whereas the lead object 301 represents data for the potential loan applicant 118 at the stage when the loan applicant 118 has not been contacted yet with respect to this particular potential loan, the contact object 302 represents data for the potential loan applicant 118 after a member of the loan origination team 117 (e.g., the loan officer 107) has contacted the potential loan applicant 118. Furthermore, the opportunity object 303 represents data for a potential deal, a precursor to a loan. For example, the opportunity object 303 may include rate information and other potential loan specifics. Finally, the loan object 304 represents data for an actual loan application.

The loan origination workflow pipeline 300 represents a sequential process for generation of each of the data objects. For example, at the time of generation of the lead object 301, the loan object 304 would not have been generated yet because other objects (e.g., the contact object 302 and the opportunity object 303) have to be generated prior to generation of the loan object 304 according to the plurality of workflow rules in the rules database 121, illustrated in FIG. 1. Accordingly, in one embodiment, the loan origination workflow pipeline 300 mandates generation of the lead object 301 prior to the contact object 302, generation of the contact object 302 prior to the opportunity object 303, and generation of the opportunity object 303 prior to the loan object 304. In another embodiment, the loan origination workflow pipeline 300 may allow for simultaneous generation of subsequent objects. For example, if the lead object 301 includes property information, both a contact object 302 and an opportunity object 303 may be simultaneously, rather than sequentially, generated by the loan origination workflow pipeline 300.

In addition, the loan origination workflow pipeline 300 has a plurality of object-specific workflows, each of which corresponds to one of the plurality of data objects. For instance, the lead object 301 may have a lead object workflow 305, the contact object 302 may have a contact object workflow 306, the opportunity object 303 may have an opportunity object workflow 307, and the loan object 304 may have a loan object workflow 308. Accordingly, specific tasks may be associated with specific data objects. Furthermore, the plurality of workflow rules integrated within the workflow data structure, stored in the workflow database 120, may dictate what tasks have to be performed before another to advance within each of the object-specific workflows; such advancement, or restriction on advancement, may be visually depicted via the workflow GUI. In one embodiment, upon completion of each of the object-specific workflows, the workflow guidance interface engine 102 may allow a member of the loan origination team 117 to provide a user input via the workflow GUI to generate a subsequent data object in the loan origination workflow pipeline 300. The workflow GUI may then automatically redirect the member of the loan origination team 117 to the next data object in the loan origination workflow pipeline 300, and the initial task in the data object-specific workflow corresponding to the next data object. In an alternative embodiment, upon completion of each of the object-specific workflows, the workflow guidance interface engine 102 automatically generates a subsequent data object in the loan origination workflow pipeline 300, and automatically redirects the member of the loan origination team 117 to the next data object in the loan origination workflow pipeline 300, and the initial task in the data object-specific workflow corresponding to the next data object.

Moreover, each of the plurality of data objects may have one or more permissions for reading or writing data associated therewith. For instance, the lead object 301 may have lead object permissions 309, the contact object 302 may have contact object permissions 310, the opportunity object 303 may have opportunity object permissions 311, and the loan object 304 may have loan object permissions 312. The various permissions may be based on particular user access for a given data object. For example, the loan officer 107 may have access to read and write the lead object 301, whereas the closer 115 would not necessarily have such access because the closer 115 would not interact with the potential loan applicant 118 at the lead stage. The user permissions may be stored in a user profile database.

The various data objects, and illustrated sequence, are provided only as an example. Different, or additional, data objects, may be utilized in the loan origination process in a different sequence. Furthermore, the illustrated data objects may be generated in a different sequence.

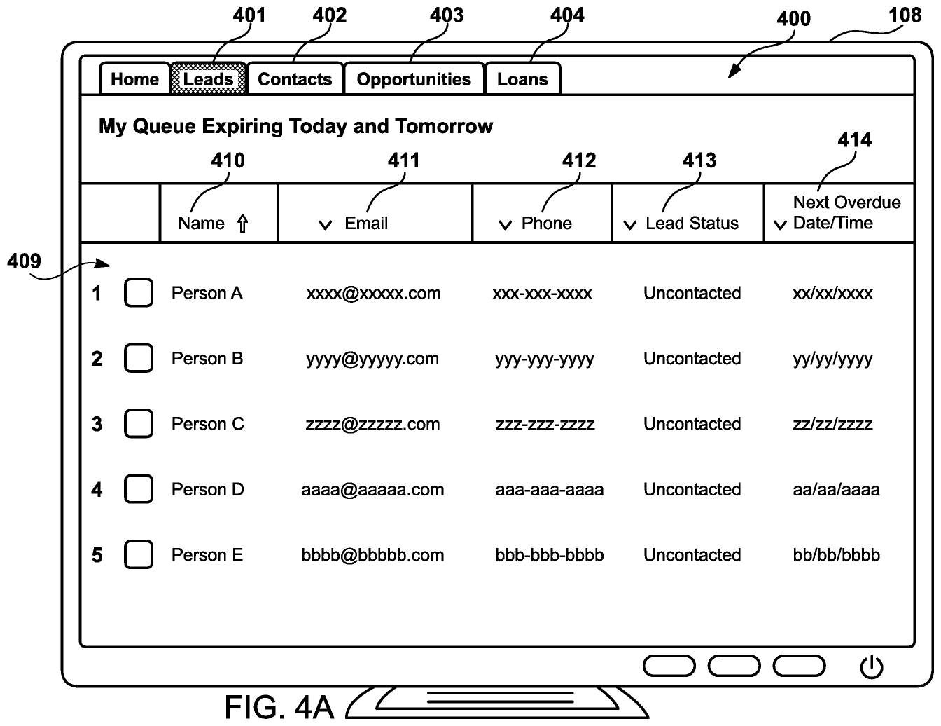

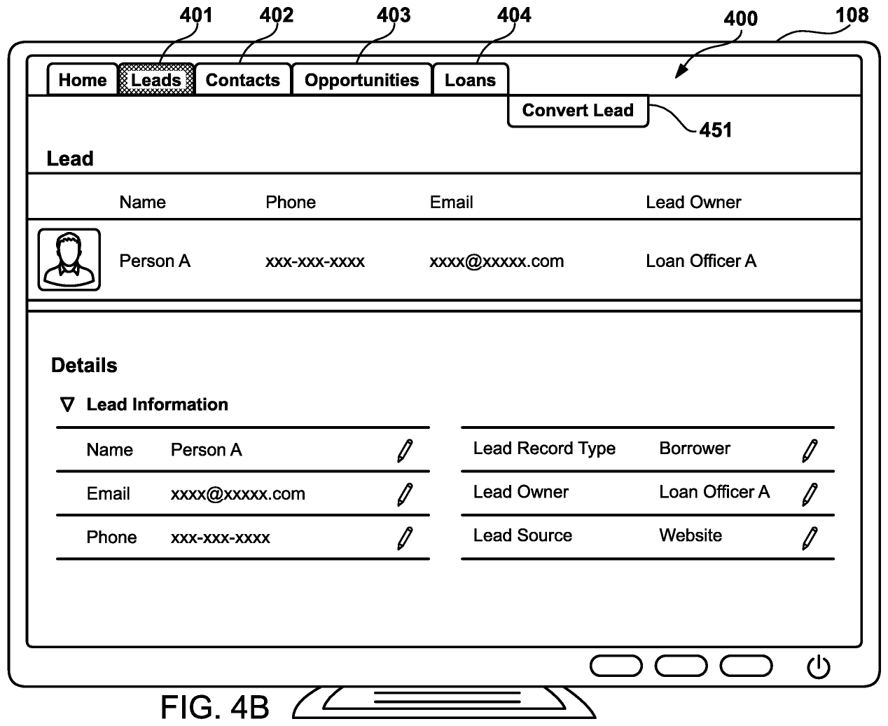

FIGS. 4A and 4B illustrate an example of the computing device 108 of the loan officer 107, illustrated in FIG. 1, rendering the workflow GUI 400 at the beginning of the loan origination workflow pipeline 300 illustrated in FIG. 3. In particular, FIG. 4A illustrates a lead list 409 that the loan officer 107 may view to initiate contact with various potential loan applicants. Furthermore, the lead list 409 may list various potential loan applicants that sent lead data (e.g., by filling out an online form that was sent to a webserver) requesting contact. In other words, the lead list 409 may be a queue of potential applicants that are awaiting contact from the loan officer 107. The lead list 409 may have various fields, such as a name field 410, an email field 411, a phone field 412, a lead status 413, and a next overdue date/time field 414. Moreover, the lead list 409 may be a data structure with one or more SLAs integrated therein. For example, the next overdue date/time field 414 may be an SLA that mandates that the loan officer 107 contact a particular potential loan applicant within a predetermined time period. If the loan officer 107 does not contact the potential loan applicant within the predetermined time period, the alert engine 103, illustrated in FIG. 1, may generate an alert that is sent to the loan officer 107 to remind the loan officer 107 to contact the potential loan applicant. Alternatively, the alert may be generated within a predetermined time period (e.g., fifteen minutes) prior to expiration of the SLA. As yet another alternative, the alert engine 103 may send an alert to another loan officer, or to a lead support specialist, if the loan officer 107 does not comply with the SLA.

FIG. 4B illustrates the workflow GUI 400 rendering a lead data entry form. In particular, the loan officer 107 may enter various information about the potential loan applicant 118 after making contact with the potential loan applicant 118. For example, the loan officer 107 may enter information such as the name of the potential loan applicant 118, email of the potential loan applicant 118, phone number of the potential loan applicant, and various other information obtained at the initial contact stage. Upon obtaining various information after making contact, the loan officer 107 may provide a user input via a convert lead indicium 451 (e.g., virtual button). In one embodiment, as a result of the user input to activate the convert lead indicium 451, the workflow GUI 400 may advance from the lead object 301 of the loan origination workflow pipeline 300, illustrated in FIG. 3, to the contact object 302 of the loan origination workflow pipeline 300.

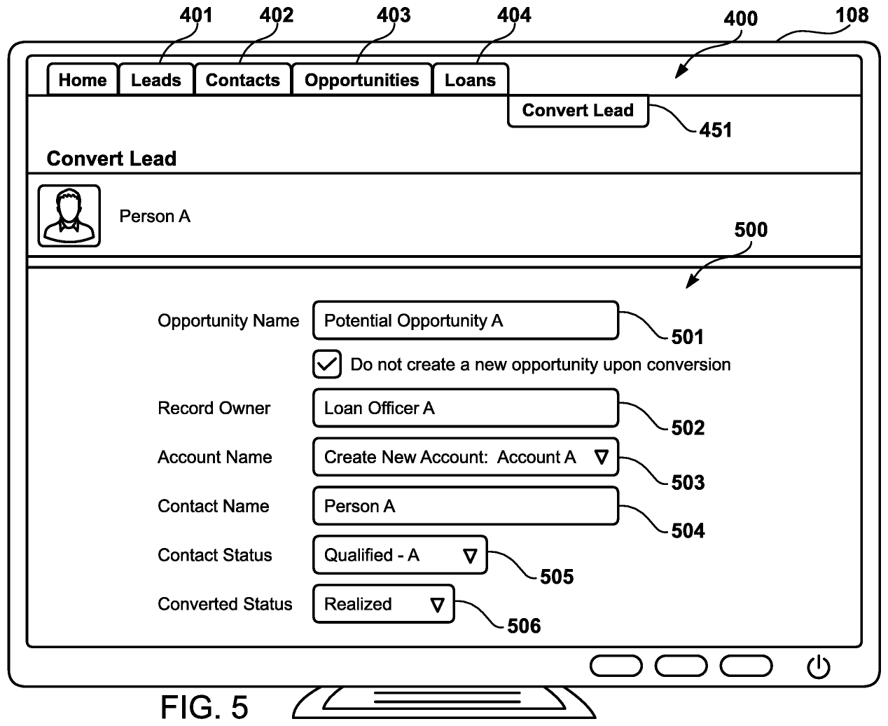

In another embodiment, prior to generating the contact object 302 illustrated in FIG. 3, the workflow guidance interface engine 102 of the computer-implemented LOS platform 101 illustrated in FIG. 1 may direct the loan officer 107 to a disposition form. FIG. 5 illustrates the workflow GUI 400 depicting a disposition form 500. In essence, the disposition form is an intermediary form that is filled out in between completion of a workflow for an object and generation of a new object. In particular, the disposition form may include various additional data fields for the loan officer 107 to provide user inputs to be able to complete generation of the lead object 302. For example, the disposition form 500 may include an opportunity name field 501, and allow or disallow simultaneous generation of an opportunity object 303 upon generation of the contact object 302. The disposition form 500 may also include a record owner field 502 to indicate the person (e.g., the loan officer 107) that filled out the disposition form. Furthermore, the disposition form 500 may include an account name field 503 to name the account and a contact name field 504 to name the contact. Additionally, the disposition form 500 has a contact status field 505 that allows the loan officer 107 to provide a user input indicating a qualification tier (e.g., Tier A, Tier B, etc.) of the contact. Based on the qualification tier, the workflow guidance interface engine 102 may assign a plurality of workflow rules to the particular contact object 302 that is about to be generated after completion of the disposition form 500 by the loan officer 107. For example, the workflow guidance interface engine 102 may visually generate less requirements for a higher qualification tier than a lower qualification tier. Finally, the disposition form 500 may indicate a converted status field 506 to indicate whether the loan officer 107 wants to generate the contact object 302. At completion of the disposition form 500, the contact object 302 is generated.

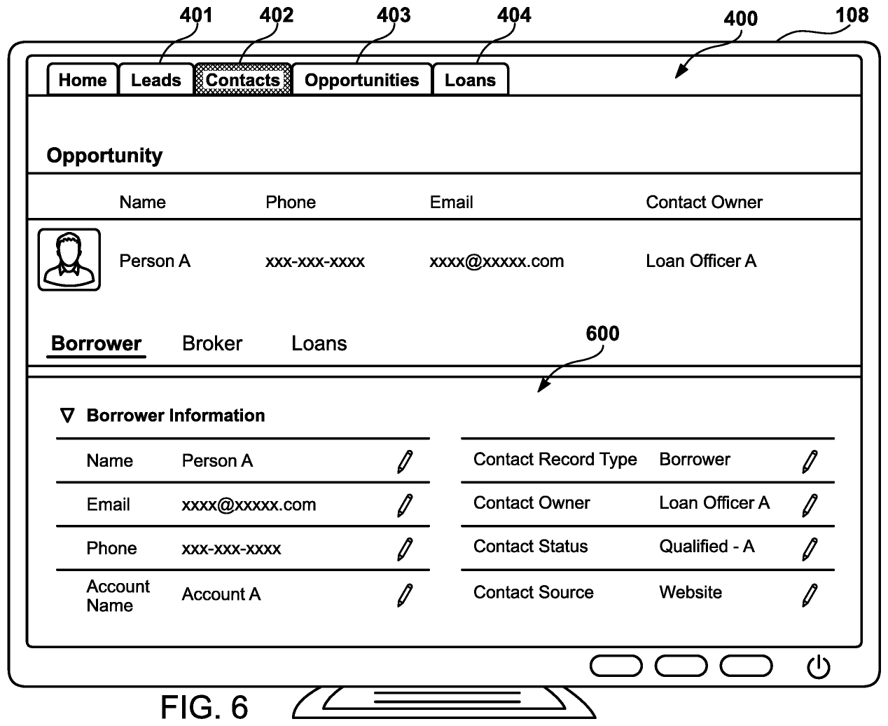

In one embodiment, the workflow GUI 400 is configured to automatically redirect rendering of the plurality of object indicia to the contact object indicium 402 at the completion of the disposition form 500 illustrated in FIG. 5. Accordingly, FIG. 6 illustrates the workflow GUI 400 rendering the plurality of object indicia 401-404 with redirection to the contact object indicium 402. Furthermore, FIG. 6 illustrates a borrower summary 600. Various other data may be viewed via a menu including the borrower, broker, and loans data. Upon providing various property information, if not already provided when generating the lead object 301 illustrated in FIG. 3, the workflow guidance interface engine 102 generates an opportunity object 303, either automatically or based upon a user input.

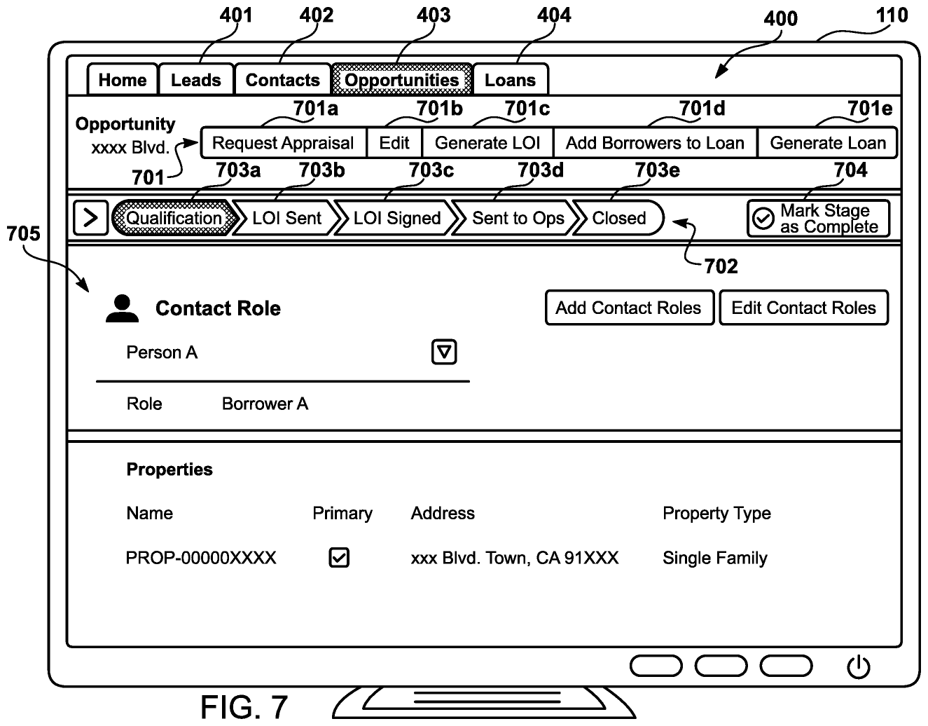

FIG. 7 illustrates the computing device 110, corresponding to the transaction coordinator 109, rendering the workflow GUI 400 to depict the opportunities object indicium 403 indicating the current stage in the loan origination workflow pipeline 300 as being the opportunity object 303, illustrated in FIG. 3. (The transaction coordinator 109 is provided only as an example, given that other members of the loan origination team 117 may also have access to the opportunity object 303.) In particular, the workflow GUI 400 illustrates an opportunity object pipeline indicium 702 corresponding to the opportunity object workflow 307 illustrated in FIG. 3. Based on the plurality of workflow rules, the workflow GUI 400 indicates (e.g., via marking, coloring, shading, etc.) which of a plurality of sub-indicia (e.g., qualification 703a, letter of intent (“LOI”) sent 703b, LOI signed 703c, Sent to Ops 703d, and Closed 703e) in the opportunity object pipeline indicium 702 corresponds to the current stage of the object-specific workflow 307. (The closed indicium 703e may indicate that the loan application has been cancelled at the opportunity stage, rather than “closed” with respect to the loan being funded.) For example, the current stage may be indicated by the qualification sub-indicium 703a. The plurality of workflow rules may mandate that an appraisal be requested before the opportunity object workflow 307 advance to the next stage of the LOI sent sub-indicium 703b. Accordingly, the GUI workflow 400 may have a task menu 701 that allows for various tasks to be requested/performed via one or more task indicia (e.g., request appraisal indicium 701a, edit indicium 701b, generate LOI indicium 701c, add borrowers to loan indicium 701d, and generate loan indicium 701e). In one embodiment, the plurality of workflow rules prevents a member of the loan origination team 117 from advancing to one stage (e.g., the LOI signed indicium 703c) prior to a particular previous stage (e.g., the LOI sent indicium 703b) being completed. The transaction coordinator 109, or other member of the loan origination team 117 with access to the opportunities object 303, may provide a user input to a mark stage as complete indicium 704 to indicate that a particular sage in the opportunity object pipeline indicium 702 has been completed. Alternatively, the workflow guidance interface engine 102 automatically detects stage completion without a user input at a mark stage as complete indicium 704. Moreover, the transaction coordinator 109, or other member of the loan origination team 117 with access to the opportunities object 303, may also add additional data through a contact roles form 705.

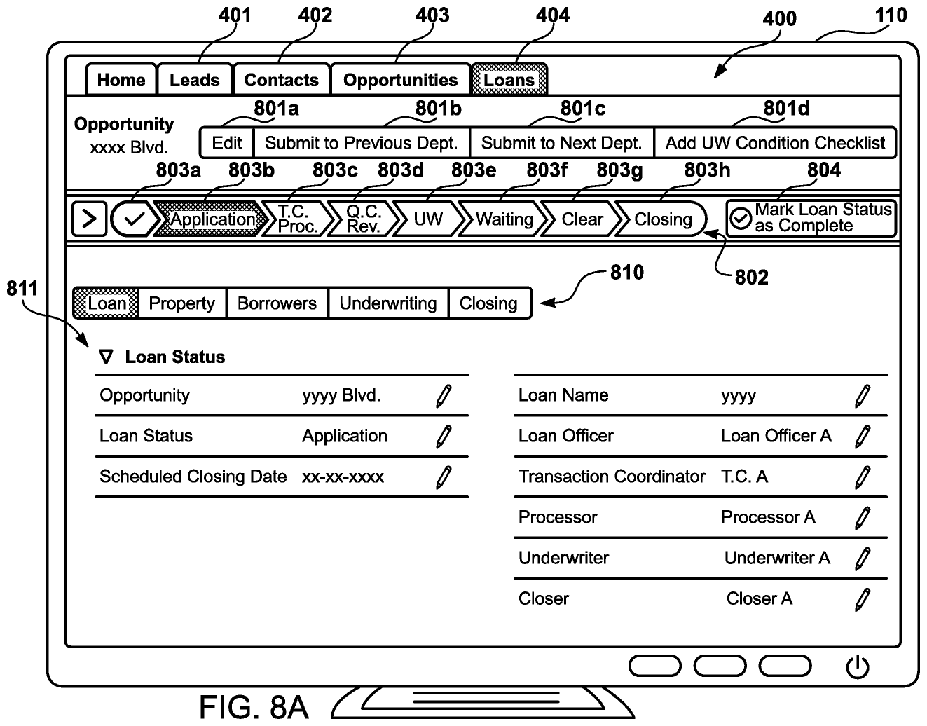

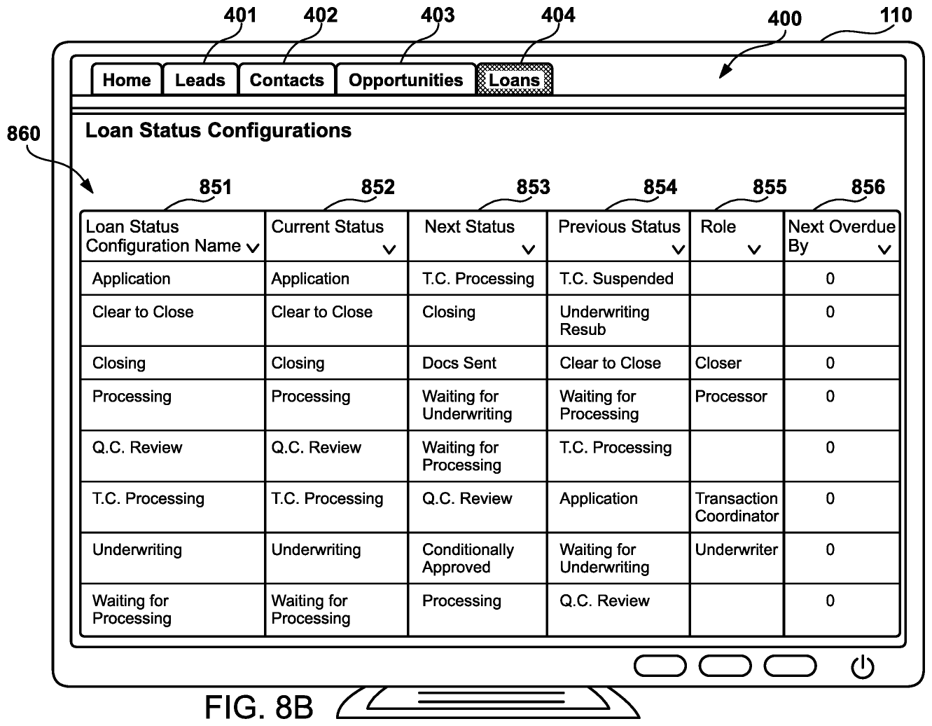

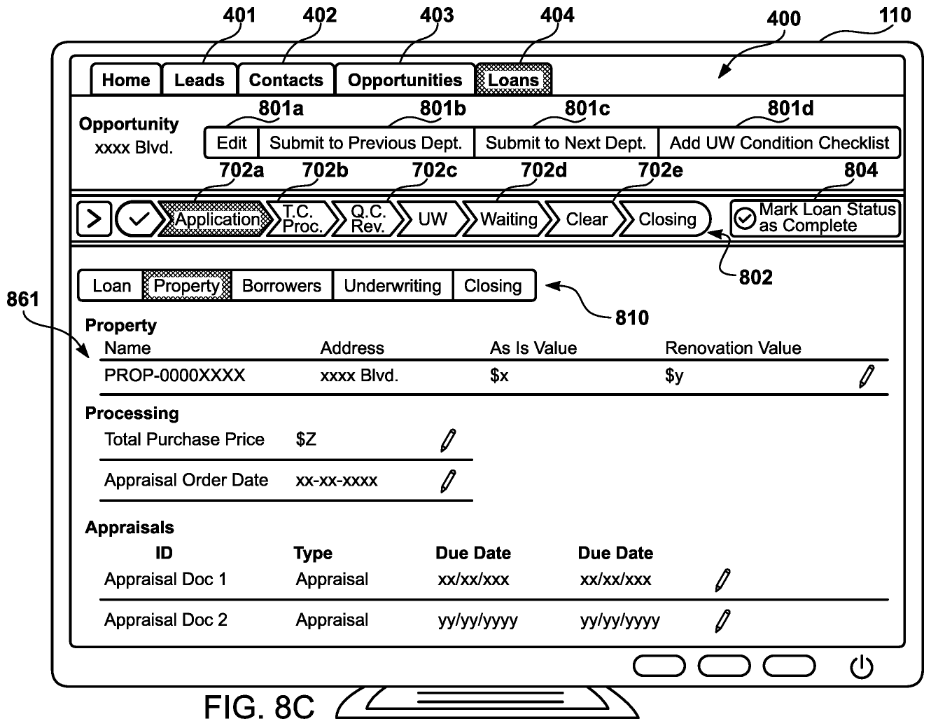

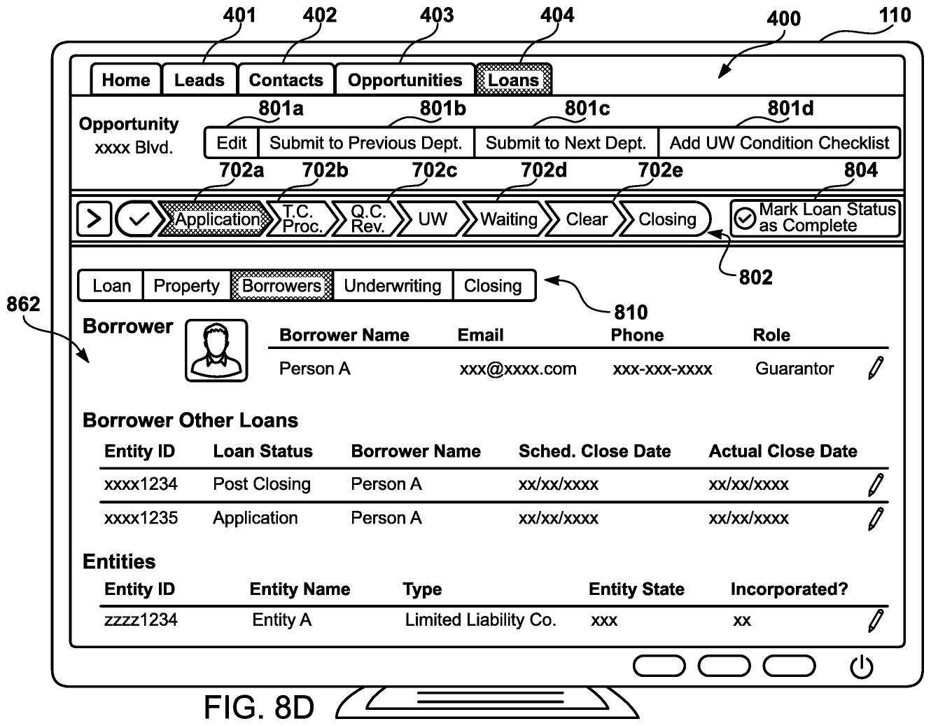

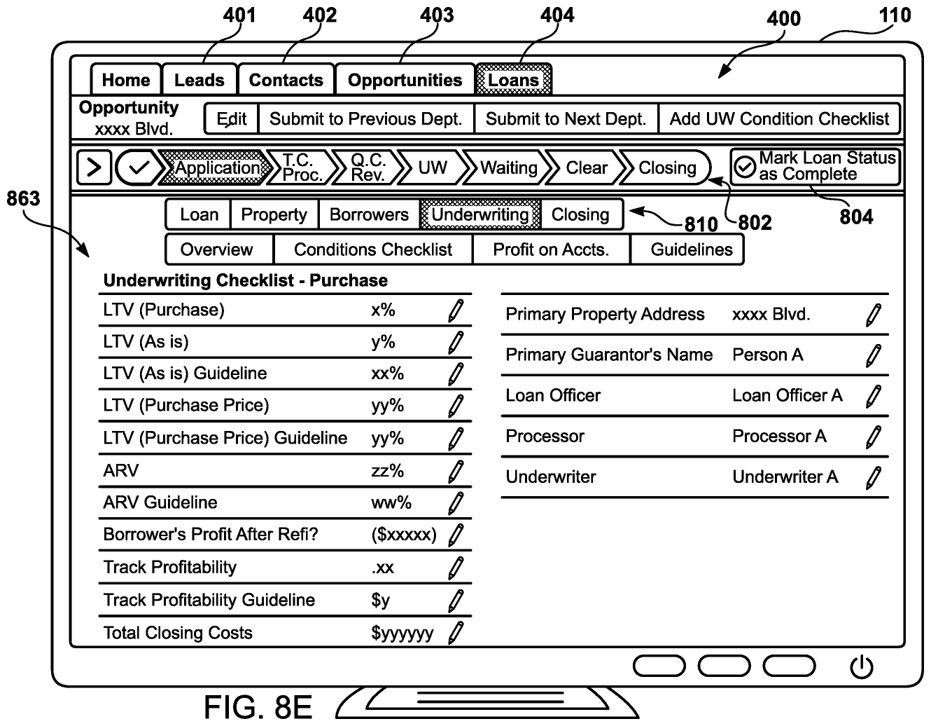

Upon completion of the opportunity object workflow 307, illustrated in FIG. 3, as rendered by the opportunity object pipeline indicium 702, illustrated in FIG. 7, the workflow guidance interface engine 102 may automatically redirect the workflow GUI 400 to the loan object 404. FIGS. 8A-8E illustrate the loan stage of the loan origination workflow pipeline 300 after generation of the loan object 304. In particular, FIG. 8A illustrates redirection to the loan object indicium 404. A loan object pipeline indicium 802 is rendered to depict a plurality of stages (e.g., loan generation indicium 803a, loan application indicium 803b, T.C. processing indicium 803c, Q.C. review indicium 803d, waiting for processing indicium 803e, underwriting indicium 803f, clear to close indicium 803g, and closing indicium 803h) of the loan object workflow 308 illustrated in FIG. 3. (The illustrated loan object stages are provided only as examples; more or fewer stages may be implemented in the loan object workflow 308.) The user may provide a user input to a mark a status as complete indicium 804 to provide a final confirmation after completion of a task in the loan object workflow 308. Alternatively, the workflow guidance interface may automatically detect completion of a task in the loan object workflow 308 without a user input to mark a status as complete indicium 804. A loan object data menu 810 may indicate various menu options (e.g., loan, property, borrowers, underwriting, and closing) to display data corresponding to the loan object 304. For example, FIG. 8A illustrates loan data 811 being selected from the loan object data menu 810.

Also, the workflow GUI 400 may render various task indicia (e.g., edit indicium 801a, submit to a previous department indicium 801b, submit to next department indicium 801c, add underwriter condition checklist 801d) that may be activated to advance through the loan object workflow 308, as rendered by the loan object pipeline indicium 802.

Also, the loan data 811 may depict various data items that may particular to the loan data object. For example, the loan data 811 illustrates an opportunity name, loan status, scheduled closing date, loan name, loan officer name, transaction coordinator name, processor name, underwriter name, and closer name. (The illustrated loan data 811 is provided only as an example.).

For ease of illustration, only a small number of stages are illustrated in the loan object pipeline indicium 802 of FIG. 8A. A variety of other stages (e.g., complete, conditionally approved, documents sent, dormant, loan cancelled, post closing, post closing documents needed, suspended, T.C. suspended, underwriting resubmission, waiting for underwriting, wire sent, etc.) may additionally, or alternatively, be displayed via corresponding indicia in the loan object pipeline indicium 802.

FIG. 8B illustrates an example of a workflow data structure 860 that may be utilized to indicate rules for advancement and/or retreat within an object-specific workflow, such as the loan object workflow 308, as well as advancement and/or retreat within the corresponding pipeline indicium, such as the loan object pipeline indicium 802, illustrated in FIG. 8A. (Additional workflow data structures may be generated for other object-specific workflows and/or corresponding loan object pipeline indicia.) As an example, the workflow data structure 860 may be a two-dimensional array that is visually represented in the form of a table. (Other types of data structures (e.g., on-dimensional array, linked list, etc., may be used instead, since a two-dimensional array is provided only as an example.) Various rows may refer to different states in the loan object pipeline indicium 802 (e.g., application, clear to close, closing, processing, Q.C. review, T.C. processing, underwriting, and waiting for processing.) Further, various columns may refer to various data corresponding to the loan data object and/or workflow rules corresponding to the loan data object. For example, a loan status configuration name field 851 may refer to the name of a particular status. Furthermore, a current status field 852 may indicate the current status. Additionally, advancement/retreat workflow rules may be indicated by a next status field 853 and a previous status field 854. In essence, the workflow rules regarding advancement/retreat are integrated within the structure of the workflow data structure 860 itself, as indicated by the current status field 852, the next status field 853, and the previous status field 854.

Furthermore, the workflow data structure 860 may have role field 855 that indicates a role of a member of the loan origination team 117 that is responsible for performing a task corresponding to the loan object workflow 308. Additionally, the workflow data structure 860 may have an integrated SLA, such as the next overdue by field 856. In essence, the workflow data structure 860 may impose an SLA on a particular role to complete a task in the loan object workflow 308. If the SLA is not met, an alert may be sent, via the alert engine 103 illustrated in FIG. 1, to the member of the loan origination team 117 corresponding to the role. Alternatively, if the SLA is not met, the workflow interface engine 102 may automatically retreat to a previous stage in the loan object workflow 308, and may visually indicate such retreat via the loan object pipeline indicium 802 illustrated in FIG. 8A.

Moreover, FIG. 8C illustrates an example of a property item being selected from the loan object data menu 810. Accordingly, property data 861 is rendered. Additionally, FIG. 8D illustrates an example of a borrower item being selected from the loan object data menu 810. As a result, borrower data 862 is rendered. Finally, FIG. 8E illustrates an example of an underwriter item being selected from the loan object data menu 810. Underwriter data is then rendered. A closing item may also be selected from the loan object data menu 810, and closing data may be rendered.

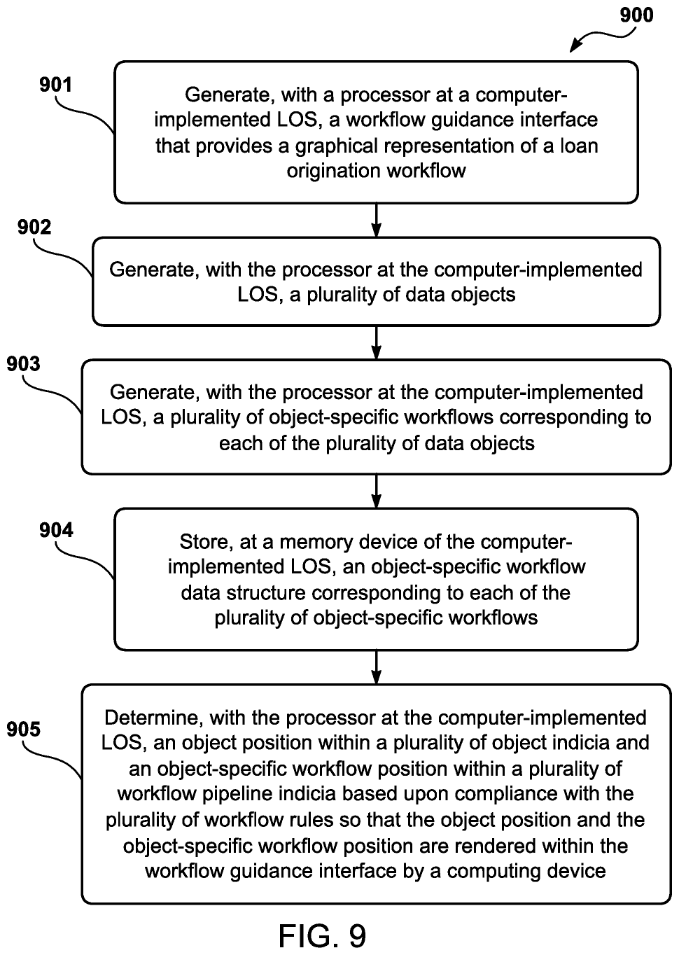

FIG. 9 illustrates a process 900 that may be utilized by the computer-implemented LOS platform 101 to provide a workflow guidance interface. At a process block 901, the process 900 generates, with the processor 201 at the computer-implemented LOS, a workflow guidance interface that provides a graphical representation of a loan origination workflow. The workflow guidance interface simultaneously operates in conjunction with the computer-implemented LOS. Further, at a process block 902, the process 900 generates, with the processor 201 at the computer-implemented LOS, a plurality of data objects. The plurality of data objects include the lead object 301, the contact object 302, the opportunity object 303, and the loan object 304, as illustrated in FIG. 3. Alternatively, the plurality of data objects may include only some of the foregoing data objects illustrated in FIG. 3. Moreover, at a process block 903, the process 900 generates, with the processor 201 at the computer-implemented LOS, a plurality of object-specific workflows corresponding to each of the plurality of data objects. The plurality of object-specific workflows comprise a lead object workflow 305, a contact object workflow 306, an opportunity object workflow 307, and a loan object workflow 308, as illustrated in FIG. 3. Alternatively, the plurality of object-specific workflows may include only some of the foregoing object-specific workflows illustrated in FIG. 3.

Moreover, at a process block 904, the process 900 stores, at the memory device 202 of the computer-implemented LOS platform 101, an object specific workflow data structure 860, as illustrated in FIG. 8B, corresponding to each of the plurality of object-specific workflows. The object specific workflow data structure 860 includes a plurality of workflow rules corresponding to advancement through each of the plurality of object-specific workflows in the workflow guidance interface.

Finally, at a process block 905, the process 900 determines, with the processor 201 at the computer-implemented LOS platform, an object position within a plurality of object indicia and an object-specific workflow position within a plurality of workflow pipeline indicia based upon compliance with the plurality of workflow rules so that the object position and the object-specific workflow position are rendered within the workflow guidance interface by a computing device. The plurality of object indicia corresponds to the plurality of data objects. Furthermore, the plurality of workflow pipeline indicia correspond to the plurality of object-specific workflows.

Various examples have been provided with respect to the mortgage lending industry. Alternatively, the LOS platform 101 may be utilized for other types of loans.

Furthermore, various illustrations have depicted computing devices such as desktop computers. However, the configurations provided for herein may be implemented via mobile computing devices (e.g., smartphones, tablet devices, smartwatches, etc.). For example, a member of the loan origination team 117 may access the workflow GUI and/or receive an alert via a mobile computing device.

A computer is intended herein to include any device that has a specialized processor as described above. For example, a computer may be a personal computer (“PC”), laptop computer, set top box, cell phone, smartphone, tablet device, smart wearable device, portable media player, video player, etc.

It is understood that the apparatuses, systems, computer program products, and processes described herein may also be applied in other types of apparatuses, systems, computer program products, and processes. Those skilled in the art will appreciate that the various adaptations and modifications of the embodiments of the apparatuses described herein may be configured without departing from the scope and spirit of the present apparatuses, systems, computer program products, and processes. Therefore, it is to be understood that, within the scope of the appended claims, the present apparatuses, systems, computer program products, and processes may be practiced other than as specifically described herein.

We claim:

1. A computer program product comprising a non-transitory computer readable medium having a computer readable program stored thereon, wherein the computer readable program when executed on a computer causes the computer to:
generate, with a processor at a computer-implemented loan origination system, a workflow guidance interface that provides a graphical representation of a loan origination workflow, the workflow guidance interface simultaneously operating in conjunction with the computer-implemented loan origination system;
generate, with the processor at the computer-implemented loan origination system, a plurality of data objects, the plurality of data objects comprising a lead object, a contact object, an opportunity object, and a loan object;
generate, with the processor at the computer-implemented loan origination system, a plurality of object-specific workflows corresponding to each of the plurality of data objects, the plurality of object-specific workflows comprising a lead object workflow, a contact object workflow, an opportunity object workflow, and a loan object workflow;
store, at a memory device of the computer-implemented loan origination system, an object specific workflow data structure corresponding to each of the plurality of object-specific workflows, the object-specific workflow data structure comprising a plurality of workflow rules corresponding to advancement through each of the plurality of object-specific workflows in the workflow guidance interface;
determine, with the processor at the computer-implemented loan origination system, an object position within a plurality of object indicia and an object-specific workflow position within a plurality of workflow pipeline indicia based upon compliance with the plurality of workflow rules so that the object position and the object-specific workflow position are rendered within the workflow guidance interface by a computing device, the plurality of object indicia corresponding to the plurality of data objects, the plurality of workflow pipeline indicia corresponding to the plurality of object-specific workflows.

2. The computer program product of claim 1, wherein the plurality of workflow rules further correspond to advancement from one of the plurality of object indicia to another one of the plurality of object indicia within the workflow guidance interface.

3. The computer program product of claim 1, wherein the object specific data structure comprises a two-dimensional array, wherein a plurality of fields indicate one or more of the plurality of workflow rules associated with advancement through the workflow guidance interface.

4. The computer program product of claim 3, wherein the object specific data structure comprises a two-dimensional array, wherein a field indicates a service level agreement that imposes a time restriction on advancement from the object position to an additional object position.

5. The computer program product of claim 4, wherein the processor generates an alert based on a predetermined time threshold being exceeded, the predetermined time threshold being an amount of time to which the time restriction would lack compliance.

6. The computer program product of claim 1, wherein the processor automatically performs redirection from the object position within the plurality of object indicia to a subsequent object position within the plurality of object indicia based on completion of an object-specific workflow.

7. The computer program product of claim 6, wherein the processor automatically performs data propagation from one of the plurality of data objects to another of the plurality of data objects based on the redirection.

8. The computer program product of claim 6, wherein the processor automatically performs data propagation from one of the plurality of object-specific workflows to another of the plurality of object-specific workflows.

9. The computer program product of claim 1, wherein the processor automatically generates a geographic-specific template based on requirements specific to a particular geographic area for loan origination.

10. The computer program product of claim 1, wherein the plurality of workflow rules are based on one or more user inputs via the workflow guidance interface.

11. A computer-implemented loan origination system comprising:
a memory device that stores an object specific workflow data structure corresponding to each of a plurality of object-specific workflows, the object specific workflow data structure comprising a plurality of workflow rules corresponding to advancement through each of the plurality of object-specific workflows in a workflow guidance interface that provides a graphical representation of a loan origination workflow; and
a processor that generates the workflow guidance interface, generates a plurality of data objects, generates the plurality of object-specific workflows corresponding to each of the plurality of data objects, and determines an object position within a plurality of object indicia and an object-specific workflow position within a plurality of workflow pipeline indicia based upon compliance with the plurality of workflow rules so that the object position and the object-specific workflow position are rendered within the workflow guidance interface by a computing device, the workflow guidance interface simultaneously operating on a computing device in conjunction with the computer-implemented loan origination system, the plurality of data objects comprising a lead object, a contact object, an opportunity object, and a loan object, the plurality of object-specific workflows comprising a lead object workflow, a contact object workflow, an opportunity object workflow, and a loan object workflow, the plurality of object indicia corresponding to the plurality of data objects, the plurality of workflow pipeline indicia corresponding to the plurality of object-specific workflows.

12. The computer-implemented loan origination system of claim 11, wherein the plurality of workflow rules further correspond to advancement from one of the plurality of object indicia to another one of the plurality of object indicia within the workflow guidance interface.

13. The computer-implemented loan origination system of claim 12, wherein the object specific data structure comprises a two-dimensional array, wherein a plurality of fields indicate one or more of the plurality of workflow rules associated with advancement through the workflow guidance interface.

14. The computer-implemented loan origination system of claim 13, wherein the object specific data structure comprises a two-dimensional array, wherein a field indicates a service level agreement that imposes a time restriction on advancement from the object position to an additional object position.

15. The computer-implemented loan origination system of claim 14, wherein the processor generates an alert based on a predetermined time threshold being exceeded, the predetermined time threshold being an amount of time to which the time restriction would lack compliance.

16. The computer-implemented loan origination system of claim 15, wherein the processor automatically performs redirection from the object position within the plurality of object indicia to a subsequent object position within the plurality of object indicia based on completion of an object-specific workflow.

17. The computer-implemented loan origination system of claim 16, wherein the processor automatically performs data propagation from one of the plurality of data objects to another of the plurality of data objects based on the redirection.

18. The computer-implemented loan origination system of claim 16, wherein the processor automatically performs data propagation from one of the plurality of object-specific workflows to another of the plurality of object-specific workflows.

19. The computer-implemented loan origination system of claim 11, wherein the processor automatically generates a geographic-specific template based on requirements specific to a particular geographic area for loan origination.

20. The computer-implemented loan origination system of claim 11, wherein the plurality of workflow rules are based on one or more user inputs via the workflow guidance interface.
